(19) United States
(12) Patent Application Publication
(10) Pub. No.: US 2024/0242112 A1
(43) Pub. Date: Jul. 18, 2024

(54) FEDERATED GLOBAL BATCH NORMALIZATION WITH SECURE AGGREGATION FOR FEDERATED LEARNING

(71) Applicant: Dell Products L.P., Round Rock, TX (US)

(72) Inventors: Paulo Abelha Ferreira, Rio de Janeiro (BR); Pablo Nascimento da Silva, Niterói (BR)

(21) Appl. No.: 18/154,407

(22) Filed: Jan. 13, 2023

(51) Int. Cl. G06N 20/00; G06F 17/11

(52) U.S. Cl. CPC G06N 20/00; G06F 17/11

(57) ABSTRACT

Federating batch normalization layers in federated learning is disclosed. Statistics including a sum of inputs to a batch normalization layer, a sum of squares of inputs to the batch normalization layer, and a sum of a number of inputs to a local model are tracked and aggregated with similar sums from other nodes. A global mean and a global variance are generated from the aggregated sums and synchronized back to local models such that the bath normalization layers of the local models are federated.

### FIELD OF THE INVENTION

Embodiments of the present invention generally relate to federated learning. More particularly, at least some embodiments of the invention relate to systems, hardware, software, computer-readable media, and methods for federated global batch normalization.

### BACKGROUND

Federated learning (FL) is a strategy for training artificial intelligence (AI) and machine learning (ML) models in a distributed manner. In federated learning, multiple nodes use their own data to train a local model. The learning is aggregated in a global model at a central node and the global model, once updated, is returned to the local nodes for further training if necessary.

These models typically include multiple layers and one of the layers in these deep learning models is referred to as a batch normalization (BN) layer. The BN layer includes learnable parameters and local parameters. The learnable parameters are often sent or represented in the gradients that are shared with the central node as part of the update. The local parameters represent local statistics of data that pass through the models. Because these statistics are often essential to breaking privacy, these statistics generated at the nodes are not shared with the server. In fact, federated learning is often performed in a manner that protects the privacy and security of the individual nodes.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of federated learning;

FIG. 2 discloses aspects of performing federated learning with federated global batch normalization layers;

FIG. 3 discloses aspects of updating batch normalization layers globally; and

FIG. 4 discloses aspects of a computing device, system, or entity.

### DETAILED DESCRIPTION OF SOME EXAMPLE EMBODIMENTS

Embodiments of the present invention generally relate to federated learning. More particularly, at least some embodiments of the invention relate to systems, hardware, software, computer-readable media, and methods for sharing batch normalization information in federated learning and related operations. Embodiments of the invention allow batch normalization layers to be updated globally without sharing the specific inputs or the specific data input to the batch normalization layers. This allows the batch normalization layers in all local models to benefit from the learning that occurs at all nodes participating the federal learning system while protecting the privacy and security of each individual node.

Federated learning may be used to train various types of Al or ML models including neural networks, deep learning models, and the like. Embodiments of the invention, however, are discussed with respect to a model, which may be implemented in various forms.

In federated learning, a model may be distributed from a central node (e.g., a server) to multiple nodes as local models for training using the respective datasets of the nodes. Thus, each of the nodes trains the model using data that is specific to the nodes. The nodes each return updates to the central node. In other words, the learning that occurs at the local nodes using the local models is aggregated and provided to the central node. The central node incorporates these updates into the central model and the central model is then redistributed to the nodes. This process may repeat until the model converges or is deemed to be sufficiently trained. Over time, the model may be retrained for various reasons such as drifting or excessive error rates. In one example, a global update, rather than the entire global model, is distributed to the individual nodes and the global update is incorporated into each of the local models at the respective nodes.

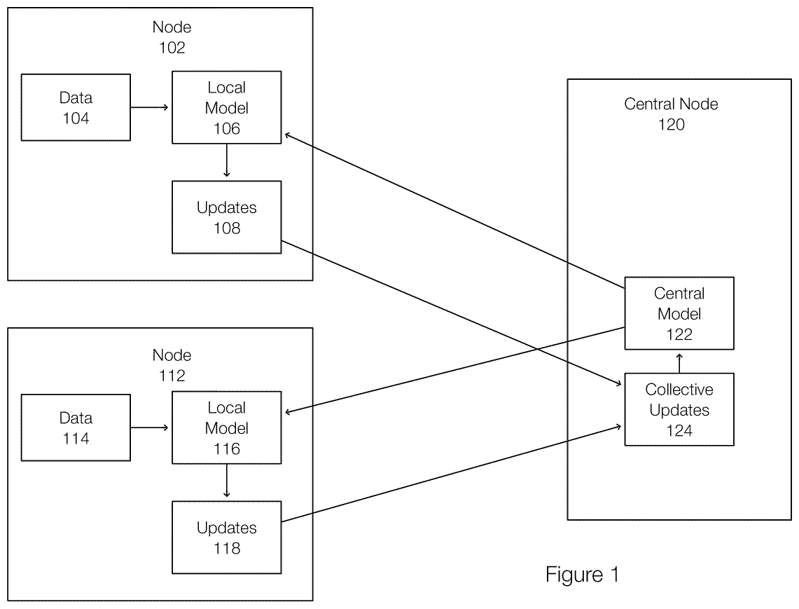

FIG. 1 discloses aspects of federated learning. As illustrated in FIG. 1, the nodes 102 and 112 each have a local model 106 and 116, respectively. The local models 106 and 116 are copies of the global or central model 122. The local model 106 is trained using data 104 and the local model 116 is trained using data 114. The data 104 is specific to the node 102 and the data 114 is specific to the node 112. The node 102 may generate updates 108 from the local model 106 and transmit the updates 108 the central node 120. Similarly, the updates 118 generated at the node 112 are also transmitted to the central node 120.

The central node 120 aggregates or combines the updates 108 and 118 into the collective updates 124, which are then applied to the central model 122. Once the collective updates 124 are incorporated into the central model 122, the central model 122 is distributed to the nodes 102 and 116. Thus, the local model 106 is updated to correspond to the latest iteration of the central model 122 or simply replaced with the central model 122. This process repeats until the local models 106 and 116 are sufficiently trained.

This federated training architecture is useful, by way of example, in edge related applications. Models can be trained in edge environments using data from the respective edges and a central model, which may be in a more central datacenter, can operate as a central node 120. Federated learning, which allows multiple nodes to contribute to the training operations, can create stronger models compared to models that are trained only at a single node. For example, federated learning allows the local model 106 to benefit from training or learning that occurred at the node 112.

There are some domains that present a frequent influx of sensitive data and are not too heterogenous, such as autonomous mobile robot images for the logistics space or security cameras in similar environments such as airports. Performing federated learning in these domains allows models to be constructed that are stable to train and that capture global statistics of the data. For example, inputs (e.g., images) at one airport may be sufficiently similar to images at other airports such that federated learning is beneficial.

The local models 106 and 116 may include one or more batch normalization layers. The batch normalization layers aid in overcoming the vanishing gradient problem and make training faster and more stable. To protect aspects of federated learning, such as privacy, federated learning may employ secure aggregation and robust aggregation (SHARE) protocols. The SHARE protocols allow a group of nodes, which may be mutually distrustful, to collaborate to compute an aggregate value without revealing private values to each other.

In addition to the SHARE protocols (or other privacy/security features of federated learning), the local parameters of the batch normalization layers are conventionally not shared or aggregated because they are essential to breaking privacy as previously stated. Consequently, federated learning does not conventionally determine or use global batch normalization statistics.

However, global batch normalization statistics would be helpful in dealing with domains, by way of example, that have a frequent influx of sensitive/valuable data and are not too heterogeneous. Embodiments of the invention relate to a federated global batch normalization layer that allows global batch normalization statistics to be generated, aggregated and employed in federated learning environments.

Embodiments of the invention thus relate to a federated global batch normalization layer and an associated communication/aggregation protocol. The protocol, by way of example, expands the single round secure aggregation step of federated learning into three stages.

The first state may occur at each of the nodes. When training the local models at the nodes, each of the local models at the nodes includes at least one batch normalization layer that is modified in accordance with embodiments of the invention. The modifications include maintaining a running sum of the inputs and a running sum of squares of the inputs. More specifically, each node i maintains a running sum (2) of the inputs and a running sum of squares (Et) of the inputs.

Second, joint computation is performed at a server or central node. Through secure aggregation, the central node determines the usual sum of all gradients, the sum of all local Σᵢ, the sum of all local Ξᵢ and the sum of all local number of data points Nᵢ.

Third, the central node may aggregate the parameters and may determine or compute the global statistics for the batch normalization layer. These global statistics can be included in the updates that are transmitted back to the nodes and incorporated into the local models. Embodiments of the invention thus relate to determining or computing global batch normalization statistics (e.g., mean and variance) in a single round with the securely aggregated information received from all nodes.

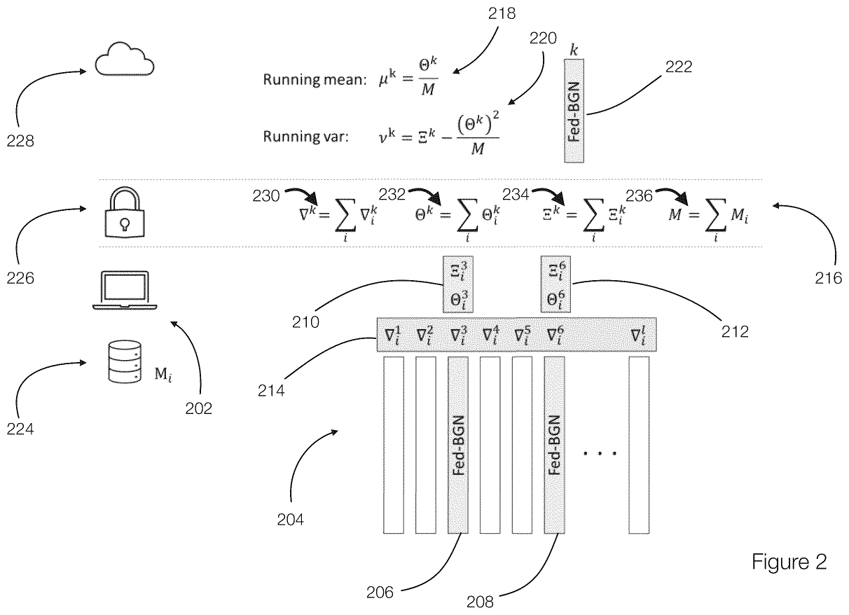

FIG. 2 discloses aspects of federated global batch normalization layers (fed-GBN) and of generating/updating fed-GBN layers. FIG. 2 illustrates various stages 224, 226, and 228 of generating, operating and/or updating fed-GBN layers. The stage 224 illustrates a node 202 with inputs (Mᵢ) that is associated with the node 202 a local model 204. In this example, the inputs (Mᵢ) are the local data points (e.g., images or features derived or determined from the images) input to the model 204. The node 202 may be an edge device, an edge network or system or other computing device/environment. By way of example, the model 204 includes fed-GBN layers 206 and 208. The number of fed-GBN layers may vary and a model such as the model 204 may include one or more fed-GBN layers.

The fed-GBN layers are associated with, conventionally, four main parameters. Two of the parameters (γ and β) are trainable or learned and two of the parameters (E[x] and Var[x]) are computed as statistics from data.

In embodiments of the invention, the trainable or learned parameters γ and β remain. However, embodiments of the invention track different statistics that allow a global mean and a global variance to be determined rather than a local mean and a local variance. If desired, the local mean and the local variance could still be tracked and determined.

In this example, the gradients 214 for each layer are tracked or determined in addition to the trainable parameters. In order to generate or determine a global mean and/or a global variance, the node 202 or the model 204 tracks the sum of the inputs across each input dimension (feature), the sum of squares of the inputs across each input dimension (feature), and the sum of the number of inputs.

In FIG. 2, the sum of the number of inputs is Mᵢ for the node 202. For the layer 206, the sum of the inputs and the sum of the squares of the inputs are represented at 210, respectively, as Θᵢ³ and Ξᵢ³. The sum and of the inputs and the sum of the squares of the inputs for the layer 208 at 212, respectively, as Θᵢ⁶ and Ξᵢ⁶. In one example, these computations may be computed more quickly than the local mean and the local variance.

The stage 224 illustrated in FIG. 2 may be present at each node Eᵢ that is participating in the federated learning operations.

The stage 226 is a secure aggregation stage that has been modified to handle the fed-GBN layers 206 and 208. In other words, because the layers 206 and 208 are tracking values (sum of inputs and sum of squares of the inputs), the protocol of the secure aggregation in the stage 226 may be modified. Generally, the secure aggregation is capable of computing sums of number in a secure manner. Conventionally, this is performed with gradients but embodiments of the invention apply the protocol to other sets of numbers/data such as the sum of the inputs and the sum of the squares of the inputs.

Secure aggregation is the process of aggregating the information used in updating the central or global model from each of the local nodes in a secure manner. Thus, the gradients from all of the nodes are aggregated, the sums of the inputs are aggregated, the sums of the squares of the inputs are aggregated, and the sums of the number of inputs are aggregated. More specifically, secure aggregation computes a sum of gradients 230, which is represented as ∇^{k}=Σᵢ∇ᵢ^{k}, and this may be performed for each relevant layer of the model 204. In addition to the sum of gradients the secure aggregation computes the sum 232 of all local inputs, which is represented as Θ^{k}=ΣᵢΘᵢ^{k}, the sum 232 of squares of the inputs, which is represented as Ξ^{k}=ΣᵢΞᵢ^{k}, and the sum 236 of the number of inputs, represented at M=ΣᵢMᵢ.

The global sums are more generally represented as: M=ΣᵢMᵢ, Θ=ΣᵢΘᵢ, and Ξ=ΣᵢΞᵢ.

Once the secure aggregation has been performed in the stage 226, the stage 228, at the central server, may compute a globally equivalent mean and a globally equivalent variance as if the central node were taking into account inputs/data from all local nodes. Embodiments of the invention allow the globally equivalent mean and variance to be determined without transmitting actual values or data from the local nodes. This enhances the privacy such that the local nodes are not required to transmit or disclose the local values.

Embodiments of the invention are distinct from simply using the mean of all local running means (e.g., E[x]) and the mean of all local running variances (Var[x]). Stated differently, a global mean of the local means may be different from a global mean that has access to all of the underlying values. For example, a first node may generate the following numbers: 2, 7, 8, and 9. A second node may generate the following numbers: 2, 3, and 4. The mean for numbers from the first node is 6.5 and the mean for the second node is 3. The mean of these two means is 4.75. However, the mean of the actual inputs 2, 7, 8, 9, 2, 3, and 4 is 5. In this example, 4.75 is not equal to 5. Embodiments of the invention generate a global mean and a global variance as if the original inputs were available to the central node using the global sums described above. This is achieved without sharing local values.

In one example, the global mean u taken across the features is

$$μ = \frac{Θ}{M} .$$

The global variance v taken across the features is

$$\\ v = Ξ - \frac{{Θ}^{{}_{} 2}}{M} .$$

As illustrated in FIG. 2, the running global mean and the running global variance for a global layer k of a global model are, respectfully:

running mean:

$$\\ {μ}^{{}_{} k} = \frac{{Θ}^{{}_{} k}}{M}$$

and running variance:

$$\\ {v}^{{}_{} k} = {Ξ}^{{}_{} k} - \frac{{( {Θ}^{{}_{} k} )}^{2}}{M} .$$

The following discussion demonstrates that the aggregation of the statistics parameters of the fed-GBN layers of the individual nodes is equivalent to the aggregation that would be obtained if all of the data from the nodes had been used for training and was available to the central node. This is achieved by illustrating that the running mean and the running variance computation is the same using embodiments of the invention and using the entire data across nodes (e.g., if the data were not private or secure).

If the data was centralized, the mean of a set of j∈J batches running through a fed-GBN layer would be given by a centralized mean μ_{c}, which is given by:

$$\\ {μ}_{c} = \frac{1}{I} {\sum }_{j} {X}_{j} .$$

Assuming that data is distributed through i∈I nodes, this could be factored as the decentralized mean μ_{d}, which is given by:

$$\\ {μ}_{d} = \frac{1}{I} {\sum }_{i} {\sum }_{j}^{{J}_{i}} {X}_{i}^{{}_{} j} .$$

In this example, I is the total number of inputs that would be taken across all nodes as the sum of all Jᵢ, which is the number of inputs at each node. Embodiments of the invention achieve the same result in the modified secure aggregation, where Θⱼ, which is the sum of all local inputs reaching a given fed-GBN layer, is tracked. In other words:

$$\\ {Θ}_{i} = {\sum }_{i} {\sum }_{j}^{{J}_{i}} {X}_{i}^{{}_{} j} and Θ = {\sum }_{i} {Θ}_{i} .$$

As a result:

$$\\ {μ}_{c} = {μ}_{d} = \frac{Θ}{I}$$

This demonstrates the equivalence of a centralized mean and a decentralized running mean for a fed-GBN layer (see

$$\\ μ = \frac{Θ}{M}$$

above).

The running variance can be similarly demonstrated. The centralized variance var_{c} is given by:

$$\\ {var}_{c} = \frac{1}{I} {\sum }_{i} {( {X}_{i} - {μ}_{c} )}^{2} .$$

Expanding this equation results in:

$$\\ I ( {var}_{c} ) = {\sum }_{i} {( {X}_{i} )}^{2} - {\sum }_{i} 2 {X}_{i} {μ}_{c} + {\sum }_{i} {( {μ}_{c} )}^{2} .$$

### Substituting

$$\\ {μ}_{c} = {μ}_{d} = \frac{Θ}{I}$$

results in:

$$\\ I ( {var}_{c} ) = {\sum }_{i} {( {X}_{i} )}^{2} - 2 \frac{{Θ}^{{}_{} 2}}{I} + \frac{{Θ}^{{}_{} 2}}{I} = {\sum }_{i} {( {X}_{i} )}^{2} - \frac{{Θ}^{{}_{} 2}}{I} .$$

In this example, Σᵢ(Xᵢ)² can be factored in a decentralized manner as:

$$\\ {\sum }_{i} {( {X}_{i} )}^{2} = {\sum }_{i} {\sum }_{j}^{{J}_{i}} {( {X}_{i}^{{}_{} j} )}^{2} .$$

As previously described, Ξᵢ=Σⱼ^{J}^{ᵢ}(Xᵢ^{j})² and Ξ=ΣᵢΞᵢ. Thus, this results in:

$$\\ {var}_{c} = Ξ - \frac{{Θ}^{{}_{} 2}}{I} .$$

This is the update for the running variance previously described (see

$$\\ v = Ξ - \frac{{Θ}^{{}_{} 2}}{M}$$

above).

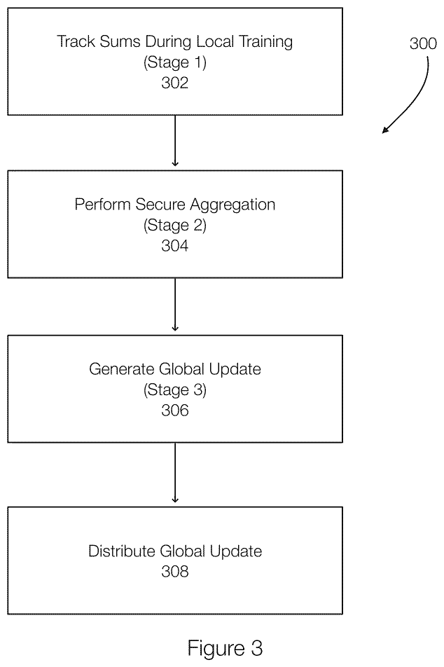

FIG. 3 discloses aspects of generating and distributing federated global batch normalization layers or parameters. In the method 300, sums are tracked 302 in a local model during stage 1 by the local model and/or by the node. The sums tracked include a sum of the inputs across each dimension, a sum of squares of the inputs across each dimension, and a sum of the number of inputs.

During stage 2, secure aggregation is performed 304. This includes generating aggregated sums which, in effect, includes aggregating the sums received from each of the nodes at the central node. Thus, a first sum is generated that includes all sums of the inputs from all of the nodes, a second sum that includes all of the sums of the squares of the inputs, and a third sum of the sums of the number of inputs received from all of the nodes. This is done in a secure manner and without sharing the actual data from the nodes.

Next, the global update is generated 306. The global update includes, in one example, a global mean and a global variance that are determined using the aggregated sums. The global update may also include updated gradients. Once the global mean and the global variance are generated, the global model is updated directly into the relevant fed-GBN layers. The update (e.g., the global mean and the global variance) are also transmitted or distributed 308 to the nodes so that the nodes can update their local fed GBN layers in the local nodes. Other layers are updated as well based on the updated gradients. Thus, the local models correspond to the central model.

Embodiments of the invention advantageously construct global BN statistics, in a secure manner, that represent the same batch normalization statistics that would be obtained if all datasets were jointly used to optimize a global model. The globally constructed BN layers (fed-GBN layers) aid, by way of example, domains with a frequent influx of sensitive or valuable data, where the statistics change frequently, and are not overly heterogeneous.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, by way of example, federated learning operations, batch normalization layer related operations, federated batch normalization layer related operations, sum tracking operations and the like or combination thereof.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter, and edge system, or the like.

Example cloud computing environments, which may or may not be public, include storage environments that may provide data processing functionality for one or more clients. Another example of a cloud computing environment is one in which processing, federated learning, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, aggregating, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures and provides the functionality of a physical computer. A VM implementation may comprise, or at least involve the use of, hardware and/or software. An

As used herein, the term ‘data’ is intended to be broad in scope. Thus, that term embraces, by way of example and not limitation, layers, gradients, sums, updates, or the like.

Example embodiments of the invention are applicable to any system capable of storing and handling various types of objects, in analog, digital, or other form.

It is noted with respect to the disclosed methods that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: tracking, for a local model operating on a node, a first sum of inputs to a batch normalization layer, a second sum of squares of the inputs to the batch normalization layer, and a third sum of a number of data points to the local model, securely aggregating the first sum, the second sum, and the third sum with first sums, second sums, and third sums from other instances of the local model operating on other nodes participating in federated learning with the node to generate an aggregated first sum, an aggregated second sum, and an aggregated third sum, determining a global mean and a global variance from the first, second, and third aggregated sums, and updating the batch normalization layer of the local model and batch normalization layers of the other instances of the local model with the global mean and the global variance.

Embodiment 2. The method of embodiment 1, further comprising updating a batch normalization layer of a central model with the global mean and the global variance.

Embodiment 3. The method of embodiment 1 and/or 2, further comprising determining a sum of gradients for layers in the local model.

Embodiment 4. The method of embodiment 1, 2, and/or 3, further comprising aggregating the sum of gradients with sums of gradients from the other instances of the local model.

Embodiment 5. The method of embodiment 1, 2, 3, and/or 4, further comprising determining the first sum across each input dimension.

Embodiment 6. The method of embodiment 1, 2, 3, 4, and/or 5, further comprising determining the second sum across each input dimension.

Embodiment 7. The method of embodiment 1, 2, 3, 4, 5, and/or 6, further comprising determining the global mean and the global variance without sharing the inputs from the local model or the other local models.

Embodiment 8. The method of embodiment 1, 2, 3, 4, 5, 6, and/or 7, wherein updating the batch normalization layer comprises synchronizing the central model to each of the nodes.

Embodiment 9. The method of embodiment 1, 2, 3, 4, 5, 6, 7, and/or 8, wherein the nodes are associated with a domain where statistics change faster than a threshold change rate.

Embodiment 10. The method of embodiment 1, 2, 3, 4, 5, 6, 7, 8, and/or 9, wherein the global mean and the global variance are configured to federate the batch normalization layer in the local models.

Embodiment 11. A system, comprising hardware and/or software, operable to perform any of the operations, methods, or processes, or any portion of any of these, or any portion thereof disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

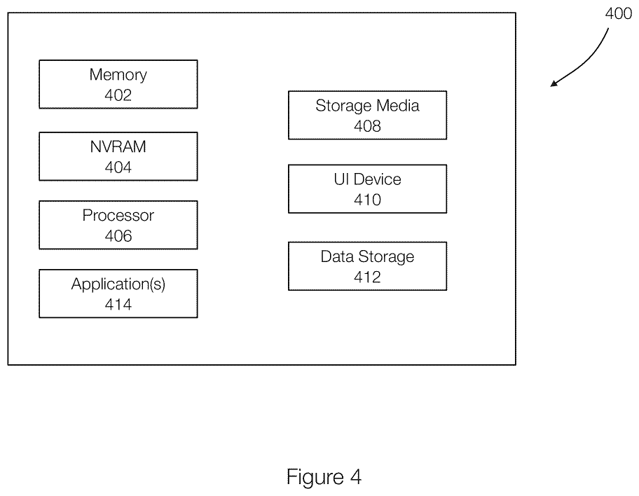

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random-access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid-state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
tracking, for a local model operating on a node, a first sum of inputs to a batch normalization layer, a second sum of squares of the inputs to the batch normalization layer, and a third sum of a number of data points to the local model;
securely aggregating the first sum, the second sum, and the third sum with first sums, second sums, and third sums from other instances of the local model operating on other nodes participating in federated learning with the node to generate an aggregated first sum, an aggregated second sum, and an aggregated third sum;
determining a global mean and a global variance from the first, second, and third aggregated sums; and
updating the batch normalization layer of the local model and batch normalization layers of the other instances of the local model with the global mean and the global variance.

2. The method of claim 1, further comprising updating a batch normalization layer of a central model with the global mean and the global variance.

3. The method of claim 1, further comprising determining a sum of gradients for layers in the local model.

4. The method of claim 3, further comprising aggregating the sum of gradients with sums of gradients from the other instances of the local model.

5. The method of claim 1, further comprising determining the first sum across each input dimension.

6. The method of claim 1, further comprising determining the second sum across each input dimension.

7. The method of claim 1, further comprising determining the global mean and the global variance without sharing the inputs from the local model or the other local models.

8. The method of claim 1, wherein updating the batch normalization layer comprises synchronizing the central model to each of the nodes.

9. The method of claim 1, wherein the nodes are associated with a domain where statistics change faster than a threshold change rate.

10. The method of claim 1, wherein the global mean and the global variance are configured to federate the batch normalization layer in the local models.

11. A non-transitory storage medium having stored therein instructions that are executable by one or more hardware processors to perform operations comprising:
tracking, for a local model operating on a node, a first sum of inputs to a batch normalization layer, a second sum of squares of the inputs to the batch normalization layer, and a third sum of a number of data points to the local model;
securely aggregating the first sum, the second sum, and the third sum with first sums, second sums, and third sums from other instances of the local model operating on other nodes participating in federated learning with the node to generate an aggregated first sum, an aggregated second sum, and an aggregated third sum;
determining a global mean and a global variance from the first, second, and third aggregated sums; and
updating the batch normalization layer of the local model and batch normalization layers of the other instances of the local model with the global mean and the global variance.

12. The non-transitory storage medium of claim 11, further comprising updating a batch normalization layer of a central model with the global mean and the global variance.

13. The non-transitory storage medium of claim 11, further comprising determining a sum of gradients for layers in the local model.

14. The non-transitory storage medium of claim 13, further comprising aggregating the sum of gradients with sums of gradients from the other instances of the local model.

15. The non-transitory storage medium of claim 11, further comprising determining the first sum across each input dimension.

16. The non-transitory storage medium of claim 11, further comprising determining the second sum across each input dimension.

17. The non-transitory storage medium of claim 11, further comprising determining the global mean and the global variance without sharing the inputs from the local model or the other local models.

18. The non-transitory storage medium of claim 11, wherein updating the batch normalization layer comprises synchronizing the central model to each of the nodes.

19. The non-transitory storage medium of claim 11, wherein the nodes are associated with a domain where statistics change faster than a threshold change rate.

20. The non-transitory storage medium of claim 11, wherein the global mean and the global variance are configured to federate the batch normalization layer in the local models.
